(19) United States
(12) Patent Application Publication
(10) Pub. No.: US 2007/0299997 A1
(43) Pub. Date: Dec. 27, 2007

(54) Information processing apparatus and control method thereof

(75) Inventor: Yoshiki Yasui, Hamura-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/812,835

(22) Filed: Jun. 22, 2007

(30) Foreign Application Priority Data
Jun. 27, 2006 (JP) 2006-176779

(51) Int. Cl. G06F 13/12

(52) U.S. Cl. 710/68

(57) ABSTRACT

According to one embodiment, the information processing apparatus comprises a compression control unit which performs compression processing on a data payload added to a packet output from a transaction layer of a first device and supplies the compressed data payload to a data link layer of the first device, and a decompression control unit which performs decompression processing on a compressed data payload added to a packet received by a data link layer of a second device and supplies the decompressed data payload to a transaction layer of the second device.

### CROSS-REFERENCE TO RELATED APPLICATIONS

This application is based upon and claims the benefit of priority from Japanese Patent Application No. 2006-176779, filed Jun. 27, 2006, the entire contents of which are incorporated herein by reference.

### BACKGROUND

1. Field

One embodiment of the invention relates to an information processing apparatus such as, for example, a PC (personal computer) and a control method for controlling the information processing apparatus.

2. Description of the Related Art

As is generally known, recently, a third-generation general-purpose I/O interconnect interface which is referred to as PCI Express has been adopted in an information processing apparatus such as, for example, a PC. This PCI Express, which is a specification for interconnecting devices via a communication path that is referred to as a link, is specified by PCI-SIG (peripheral component interconnect special interest group).

Meanwhile, in the PCI Express Specifications, data is transmitted between devices by using packets. In the technologies defined in the PCI Express Base Specification Revision 1.1, however, although the configuration format of the packets (Ordered-set/DLLP/TLP) transmitted between devices is defined, there is no definition about improvement in transmission efficiency through the reduction in the amount of data of the packets.

In Jpn. Pat. Appln. Publication No. 2001-285399, a configuration is disclosed, in which a data transmission node with a plurality of data compressing means having different data compression ratios carries out data compression by selecting one of the data compressing means in accordance with a data transfer effective speed at the time of data transfer, transfers the compressed data along with a data compression scheme, and decompresses the data on the basis of the data compression scheme that the data reception node has received.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 shows an embodiment of this invention and is a perspective view of an appearance of a notebook personal computer (PC) capable of battery-powered operation;

FIG. 2 is a block diagram showing a signal processing system of the PC according to the embodiment;

FIG. 3 is a view showing a connection structure between two devices in the PC according to the embodiment, the connection structure being compliant with the PCI Express Specifications;

FIG. 4 is a view showing a DLLP that carries out data transmission and reception to secure the maintainability of the data between DataLink Layers compliant with the PCI Express Specifications according to the embodiment;

FIG. 5 is a view showing a TLP that carries out data transmission and reception between Transaction Layers and between internal bus control circuits compliant with the PCI Express Specifications according to the embodiment;

FIG. 6 is a block diagram showing a state where a compression circuit and a decompression circuit are added to each of the devices in the PC according to the embodiment;

FIG. 7 is a view showing a header of a TLP transmitted between the Transaction Layers according to the embodiment;

FIGS. 8A to 8E are views each showing a common transmission scheme for the headers of an identical TLP;

FIGS. 9A to 9B are views each showing a compression scheme for the header of the TLP according to the embodiment;

FIG. 10 is a flowchart showing an operation of compression processing on a data payload or header of the TLP according to the embodiment; and

FIG. 11 is a flowchart showing an operation of decompression processing on the compressed data payload or header of the TLP according to the embodiment.

### DETAILED DESCRIPTION

Various embodiments according to the invention will be described hereinafter with reference to the accompanying drawings. In general, according to one embodiment of the invention, the information processing apparatus comprises: a compression control unit which performs compression processing on a data payload added to a packet output from a transaction layer of a first device and supplies the compressed data payload to a data link layer of the first device; and a decompression control unit which performs decompression processing on a compressed data payload added to a packet received by a data link layer of a second device and supplies the decompressed data payload to a transaction layer of the second device.

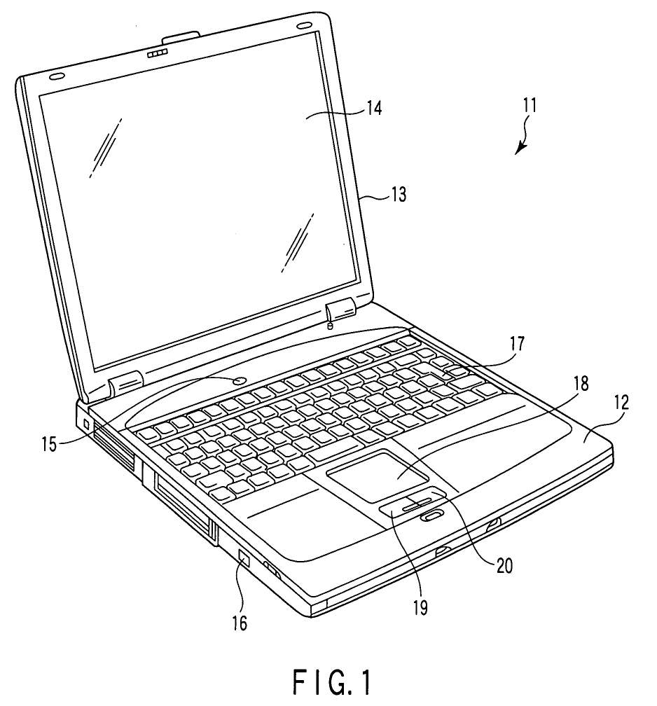

FIG. 1 shows an external view of a notebook personal computer (PC) 11 capable of battery-powered operation, employed as an information processing apparatus to be described in this embodiment.

This PC 11 comprises a PC main body 12 and display unit 13. A display device composed of a liquid crystal display (LCD) is built in the display unit 13. A display screen 14 of the LCD is placed almost in the center of the display unit 13.

The display unit 13 is mounted on the PC main body 12 so as to be pivotal between the open and closed positions. The PC main body 12 has a thin box-like housing. A power button 15, a LED (light emitting diode) display unit 16, a keyboard 17, a touch pad 18, a pair of buttons 19, 20 which are arranged side by side, and the like, are disposed on the top surface of the PC main body 12.

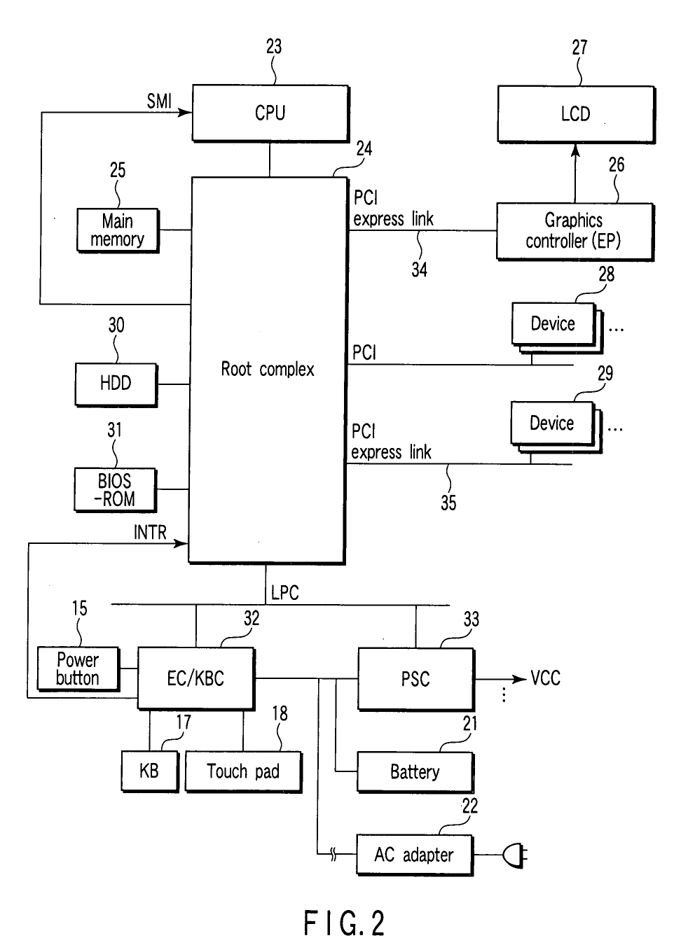

FIG. 2 shows a signal processing system of the PC 11. The PC 11, which has a built-in battery 21, operates with power from the built-in battery 21 in a state where the PC is not connected to an external power supply (AC power supply). The PC 11 operates with the external power supply (AC power supply) in a state where an AC adapter 22 is connected to the PC 11, that is, the PC 11 is connected to the external power supply (AC power supply). The built-in battery 21 is charged from the external power supply.

As shown in FIG. 2, the PC 11 incorporates a CPU (central processing unit) 23, a Root Complex 24, a main memory 25, a graphics controller (end point) 26, the display unit (LCD) 27, a PCI device group 28, a PCI Express device group 29, an HDD (hard disk drive) 30, a BIOS-ROM 31, an embedded controller/key board controller (EC/KBC) 32, a power supply controller (PSC) 33, the power button 15, keyboard (KB) 17, touch pad 18, and the like.

The Root Complex 24, graphics controller (end point) 26 and PCI Express device group 29 are devices compliant with the PCI Express Specifications, respectively. The communication between the Root Complex 24 and graphics controller (end point) 26 is executed via a PCI Express link 34 provided between the Root Complex 24 and graphics controller (end point) 26.

The communication between the Root Complex 24 and PCI Express device group 29 is executed via a PCI Express Link 35 provided between the Root Complex 24 and PCI Express device group 29. Each of the PCI Express Links 34, 35 is a communication path composed of a serial bus interface, and includes upstream lane and downstream lane.

The CPU 23, which is a processor controlling the operation of the PC 11, executes various programs (operating system, application program) which are loaded in the main memory 25 from the HDD 30.

Also, the CPU 23 executes BIOS (basic input output system) stored in the BIOS-ROM 31. The BIOS is a program for controlling hardware. Further, the BIOS has SMI (system management interrupt) routines for dynamically permitting or prohibiting the execution of ASPM (active state power management) function specified by the PCI Express Specifications, in accordance with an operation mode of the PC 11.

The ASPM function is a communication path control function capable of, for example, even if a device compliant with the PCI Express specification is in the operating state (DO state), setting the link to which the device is connected, to a low power state (standby state), as described above. Two devices interconnected via the link have the ASPM function, respectively, and in accordance with whether or not the link is in the idle state, the link can be caused to transit between the operating state and the standby state, where the power is consumed lower than in the operating state. This transition is executed automatically by hardware.

The Root Complex 24 is a bridge device connecting the local bus of the CPU 23 and the graphics controller (end point) 26. The Root Complex 24 has also a function of executing the communication with the graphics controller (end point) 26 via the PCI Express Link 34.

The graphics controller (end point) 26 is a display controller controlling the display unit (LCD) 27 used as a display monitor of the PC 11.

The embedded controller/keyboard controller (EC/KBC) 32 is a one-chip microcomputer in which an embedded controller for power management, and a keyboard controller for controlling the keyboard (KB) 17 and touch pad 18 are integrated.

This embedded controller/keyboard controller (EC/KBC) 32 has a function of, in response to the operation of the power button 15 by a user, powering on/off the PC 11 in cooperation with the power supply controller (PSC) 33. The embedded controller/keyboard controller (EC/KBC) 32 also has a function of detecting the connection/disconnection of the AC adaptor 22 to/from the PC 11.

When an event of connection or disconnection of the AC adaptor 22 occurs, the embedded controller/keyboard controller (EC/KBC) 32 generates an interrupting signal (INTR) to notify the BIOS of the occurrence of power management event. In response to the generation of the interrupting signal (INTR), the Root Complex 24 generates an interrupting signal (SMI) for the CPU 23. The CPU 23 executes the SMI routines of the BIOS in response to the SMI. Additionally, the SMI may be supplied directly to the CPU 23 from the embedded controller/keyboard controller (EC/KBC) 32.

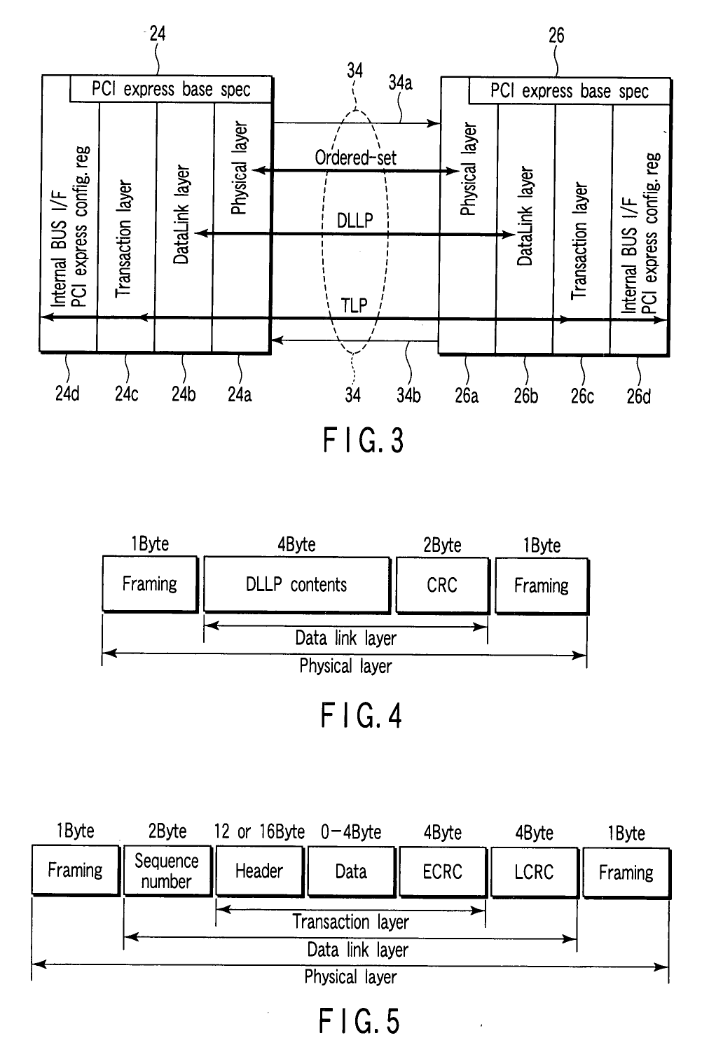

FIG. 3 shows a connection structure between two devices compliant with the PCI Express Specifications, respectively. Here, described is an example of connection structure between the Root Complex 24 (first device) and graphics controller (end point) 26 (second device) as such two devices.

Specifically, the PCI Express Specifications define Physical Layers 24a and 26a for controlling and managing the physical connection between the two devices 24 and 26 opposed each other, DataLink Layers 24b and 26b for controlling and managing the maintainability of the data transmitted between the devices, and Transaction Layers 24c and 26c for controlling and managing the transactions such as the reading or writing of data from or to the memory. Incidentally, the devices 24 and 26 incorporate internal bus control circuits 24d and 26d, respectively, for controlling and managing the interface between an internal logic and the Transaction Layers 24c and 26c. These internal bus control circuits 24d and 26d are outside the scope of the PCI Express Specifications.

Data passing is carried out between the respective layers (24a, 26a), (24b, 26b) and (24c, 26c) of the two devices 24 and 26 opposed each other through the transmission and reception of the packets defined in format by the PCI Express specifications. The packets transmitted and received between the respective layers opposed each other, (24a, 26a), (24b, 26b) and (24c, 26c) are of three types as follows:

An ordered-set that carries out data transmission and reception to control and manage the physical connection between the Physical Layers 24a and 26a; a DLLP (datalink layer packet) that carries out data transmission and reception to secure the maintainability of the data transmitted between the DataLink Layers 24b and 26b (see FIG. 4); and a TLP (transaction layer packet) that carries out data transmission and reception between the devices 24 and 26 (see FIG. 5).

The data transmitted and received by the TLP is segmentized into: Memory transaction (read/write) that transmits and receives stream data (signal) such as a control signal and video data of the opposed device; I/O transaction (read/write) that mainly transmits and receives a control signal of the opposed device; Configuration transaction which performs transmission and reception of control information which complies with PCI/PCI Express defined in PC12. x/PCI-X/PCI Express; and Message transaction that performs transmission and reception of management information such as interrupt, error information, Slot management and power control. The Configuration transaction and Message transaction are used for the management between the devices 24 and 26 and the PCI Express hierarchy, and for the transmission and reception of control information.

As has been described previously, the Root Complex 24 and graphics controller (end point) 26 are interconnected with each other via the PCI Express link 34. The PCI Express link 34 is a serial bus interface allowing point-to-point interconnections between the Root Complex 24 and graphics controller (end point) 26.

In other words, the PCI Express link 34 includes: a pair of differential signal lines 34a and 34b, wherein the signal line 34a is used to transmit information in a direction from the Root Complex 24 to the graphics controller (end point) 26, and the signal line 34b, in the opposite direction; a pair of signal lines which transmits or receives the Ordered-set between the Physical Layers 24a and 26a; a pair of signal lines which transmits or receives the DLLP between the DataLink Layers 24b and 26b; and a pair of signal lines which transmits or receives the TLP between the Transaction Layers 24c and 26c and between the internal bus control circuits 24d and 26d.

The Ordered-set and DLLP are used for local communications between the devices 24 and 26. These two types of packets do not accept user-selected data. The data format is strictly specified by the PCI Express Specifications.

On the other hand, although the packet format for the TLP is strictly specified by the PCI Express Specifications, the amount of data thereof is specified only in data length of header and data payload (Data field of FIG. 5) added to the packet. In other words, there is no definition of improving the transmission efficiency through the reduction in the amount of data of the packet.

In this embodiment, therefore, the transmission efficiency is improved in such a manner that the device of transmitting end carries out compression processing on the data payload or header of the TLP to reduce the amount of data, while the device of receiving end carries out decompression processing on the thus compressed data payload or header of the TLP to restore the amount of data.

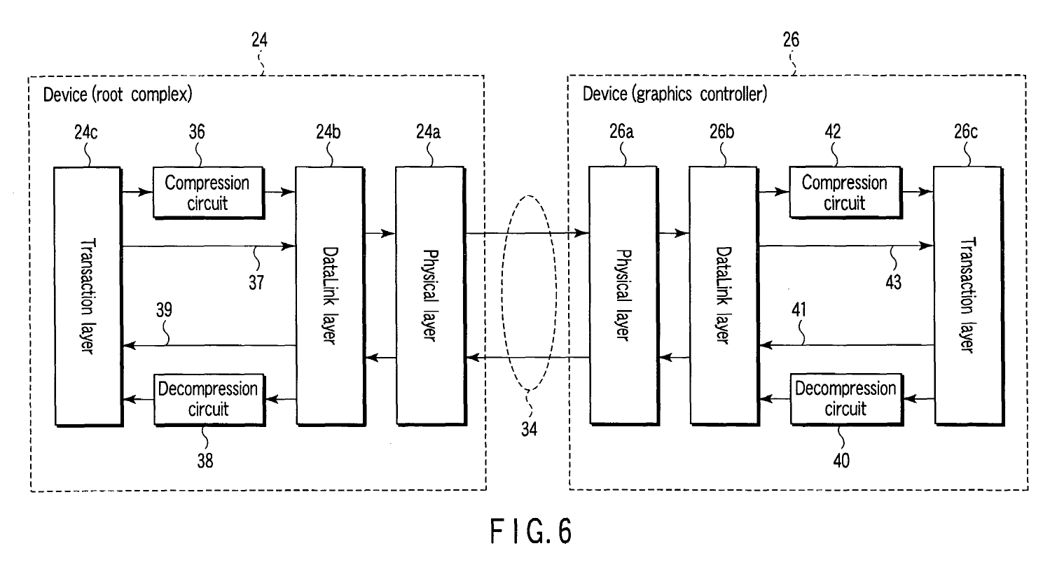

That is, as shown in FIG. 6, one of the devices, i.e., the Root Complex 24 includes a compression circuit 36 provided between the Transaction Layer 24c and DataLink Layer 24b. The compression circuit 36 carries out compression processing on the data payload or header of the TLP which is transmitted from the transaction Layer 24c to the DataLink Layer 24b so as to reduce the amount of data.

Further, between the Transaction Layer 24c and DataLink Layer 24b, there is provided a route 37 that is used to directly transmit a TLP which is not subject to compression processing, from the Transaction Layer 24c to the DataLink Layer 24b, without causing the TLP to pass through the compression circuit 36.

Furthermore, between the Transaction Layer 24c and DataLink Layer 24b, there is provided a decompression circuit 38 that carries out decompression processing on the compressed data payload or header of the TLP which is transmitted from the DataLink Layer 24b to the Transaction Layer 24c, so as to restore the amount of data.

Moreover, between the Transaction Layer 24c and DataLink Layer 24b, there is provided a route 39 that is used to directly transmit a TLP which is not subject to decompression processing, i.e., which has not been subjected to compressing processing, from the DataLink Layer 24b to the Transaction Layer 24c, without causing the TLP to pass through the decompression circuit 38.

On the other hand, also the other device, i.e., the graphics controller (end point) 26 includes a compression circuit 40 provided between the Transaction Layer 26c and DataLink Layer 26b. The compression circuit 40 carries out compression processing on the data payload or header of the TLP which is transmitted from the transaction Layer 26c to the DataLink Layer 26b so as to reduce the amount of data.

Further, between the Transaction Layer 26c and DataLink Layer 26b, there is provided a route 41 that is used to directly transmit a TLP which is not subject to compression processing, from the Transaction Layer 26c to the DataLink Layer 26b, without causing the TLP to pass through the compression circuit 40.

Furthermore, between the Transaction Layer 26c and DataLink Layer 26b, there is provided a decompression circuit 42 that carries out decompression processing on the compressed data payload or header of the TLP which is transmitted from the DataLink Layer 26b to the Transaction Layer 26c, so as to restore the amount of data.

Moreover, between the Transaction Layer 26c and DataLink Layer 26b, there is provided a route 43 that is used to directly transmit a TLP which is not subject to decompression processing, i.e., which has not been subjected to compressing processing, from the DataLink Layer 26b to the Transaction Layer 26c, without causing the TLP to pass through the decompression circuit 42.

Under the aforementioned circumstances, for example, a TLP which is output so as to be transmitted from the Transaction Layer 24c of the device 24 to the Transaction Layer 26c of the device 26 and is not subject to compression processing, is supplied to the Transaction Layer 26c via the route 37, DataLink Layer 24b, Physical Layer 24a, PCI Express link 34, Physical Layer 26a, DataLink Layer 26b and the route 43.

A TLP which is output so as to be transmitted from the Transaction Layer 24c of the device 24 to the Transaction Layer 26c of the device 26 and is subject to compression processing, is supplied to the Transaction Layer 26c via the compression circuit 36 for compression processing, DataLink Layer 24b, Physical Layer 24a, PCI Express link 34, Physical Layer 26a, DataLink Layer 26b, and then, the decompression circuit 42 for decompression processing. This allows reduction in data transmission rate on the transmission path from the DataLink Layer 24b to the DataLink Layer 26b, with an improvement in transmission efficiency.

On the contrary, a TLP which is output so as to be transmitted from the Transaction Layer 26c of the device 26 to the Transaction Layer 24c of the device 24 and is not subject to compression processing, is supplied to the Transaction Layer 24c via the route 41, DataLink Layer 26b, Physical Layer 26a, PCI Express link 34, Physical Layer 24a, DataLink Layer 24b and the route 39.

A TLP which is output so as to be transmitted from the Transaction Layer 26c of the device 26 to the Transaction Layer 24c of the device 24 and is subject to compression processing, is supplied to the Transaction Layer 24c via the compression circuit 40 for compression processing, DataLink Layer 26b, Physical Layer 26a, PCI Express link 34, Physical Layer 24a, DataLink Layer 24b, and then, the decompression circuit 38 for decompression processing. This allows reduction in data transmission rate on the transmission path from the DataLink Layer 26b to the DataLink Layer 24b, with an improvement in transmission efficiency.

The compression processing on the data payload of the TLP described above is carried out by means of, for example, the common Deflate algorithm, LZSS method, Huffman method, or the like.

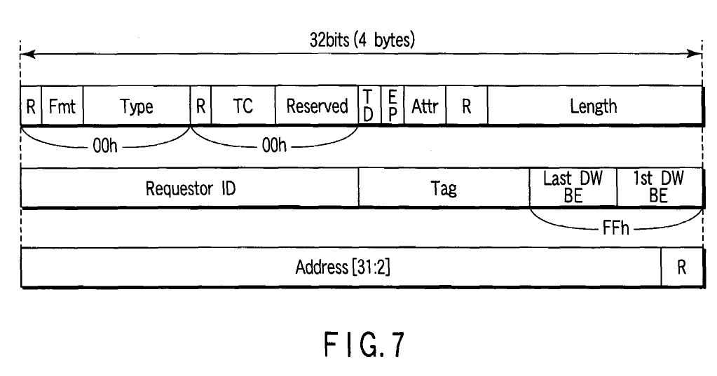

Next, the compression processing on the header of the TLP will be described. As shown in FIG. 7, this header is composed of 12 bytes (1 byte=8 bits), containing elements R, Fmt, Type, R, TC, Reserved, TD, EP, Attr, R, Length, Requester ID, Tag, Last DW, 1st DW, Address and R.

Of these, Requester ID designates a request such as write or read with respect to the opposed device, Address designates a start address for carrying out write or read with respect to the memory of the opposed device, and Length designates the number of addresses for carrying out the write or read of data from the start address.

In this case, the TLP includes two occasions: as in the case where a write request or the like is described in Requester ID of the TLP, an amount of write data corresponding to the number of addresses which is designated by Length is added as a data payload to a Data field subsequent to the header; and as in the case of a read request or the like, a data payload is not added after the header.

If, for example, the device 24 issues a read request to the device 26, the opposed device 26 outputs a TLP with data that is read out of the address which has accepted the read request and added thereto as a data payload and the TLP is supplied to the device 24.

In this case, as has been described previously, the data length of a data payload that can be added to one TLP is specified. For this reason, when data in an amount exceeding the specified data length is read out, it is necessary for the device 24 to issue a plurality of read requests, causing the opposed device 26 to read data by diving it into a plurality of TLPs.

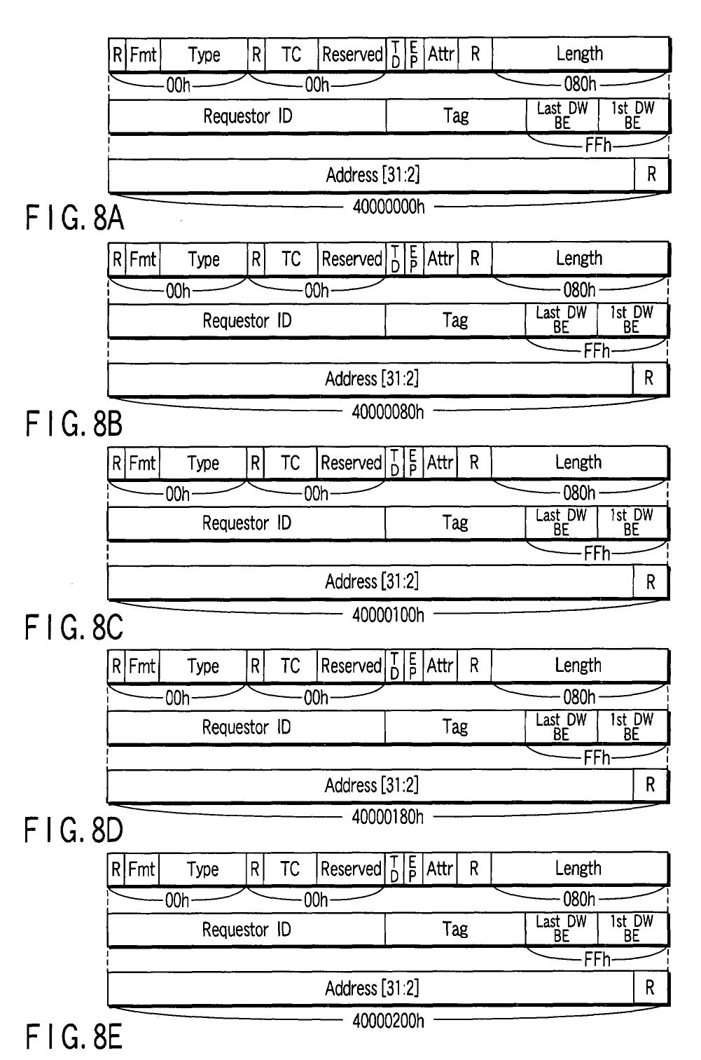

For instance, in the case where the read request is issued separately five times, five TLPs shown in FIGS. 8A to 8E are required to be generated for the opposed device 26. In this case, since one header consists of 12 bytes×8 bits=96 bits, the amount of data of 96 bits×5=480 bits in total is transmitted.

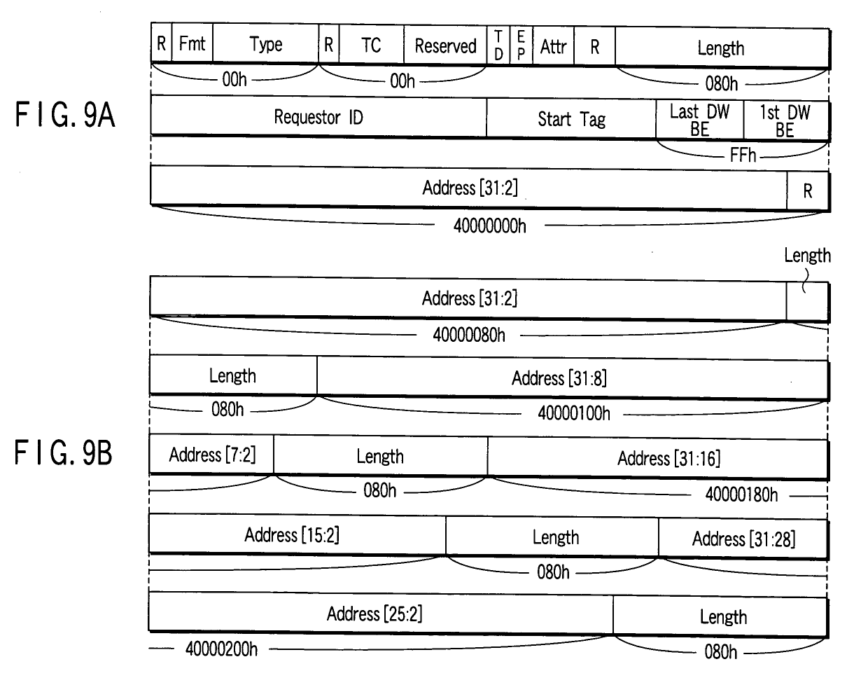

However, these five TLPs are identical with one another for the most parts except for the Length and Address. Therefore, as shown in FIG. 9A, only for the first single header, the total of 96 bits are transmitted, and for the four headers subsequent to the first header, as shown in FIG. 9B, different elements, that is, the Address and Length are consecutively transmitted. This results in the transmission of data in an amount of 32 bits×8=256 bits in total, thus reducing (compressing) the amount of data compared to the case where all five TLPs are transmitted.

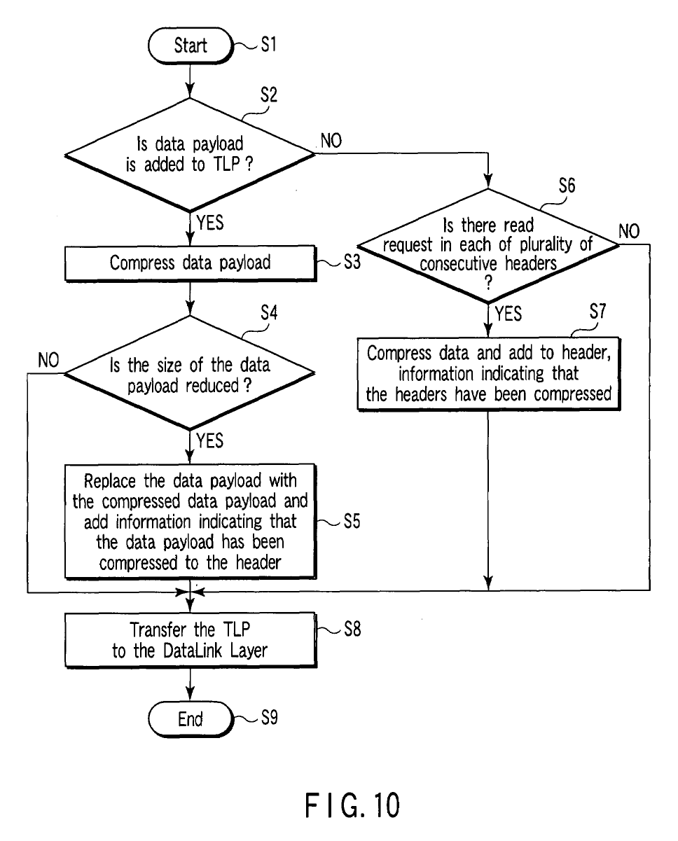

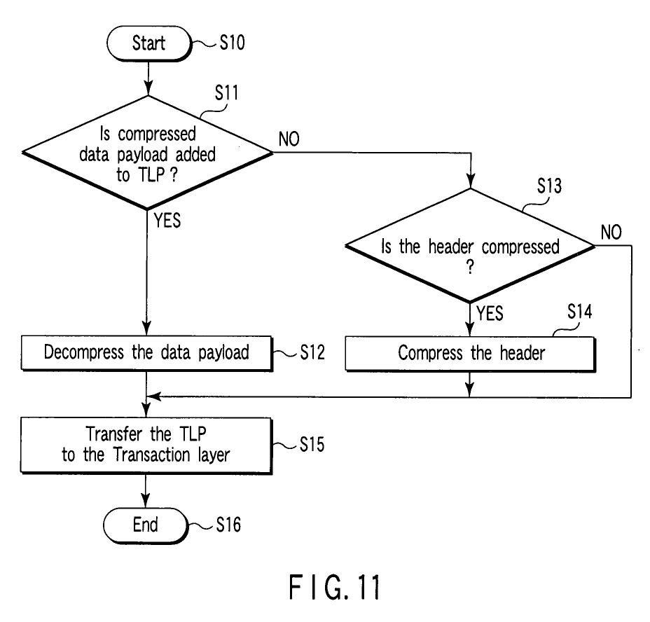

FIG. 10 is a flowchart showing an operation sequence of compressing a data payload or header of a TLP in the device 24 described above. As a matter of course, the compression processing in the device 26 also can be carried out in substantially the same manner as in the device 24.

That is, upon the start of processing (step S1), the CPU 23 determines in step S2 whether or not a data payload is added to a TLP output from the Transaction Layer 24c. When it is determined that a data payload is added to the TLP (YES), the CPU 23 supplies the TLP to the compression circuit 36 and causes the compression circuit 36 to compress the data payload in Step S3.

Thereafter, in step S4, the CPU 23 compares the amount of data (size) of the data payload before the compression processing with the amount of data (size) of the data payload after the compression processing, thereby determining whether or not the compression processing made the amount of data (size) of the data payload smaller.

Subsequently, when it is determined that the compression processing made the amount of data (size) of the data payload smaller (YES), the CPU 23 replaces the data payload of the TLP with the compressed data payload and adds to the header of the TLP information indicating that the data payload has been compressed, in Step S5.

When it is determined in Step S2 that a data payload is not added to the TLP (NO), the CPU 23 determines in step S6 whether or not a description of read request is given in each of the headers of a plurality of TLPs output consecutively from the Transaction Layer 24c.

When it is determined that a description of read request is given in each of the headers of the plurality of consecutive TLPs (YES), the CPU 23 supplies the compression circuit 36 with the plurality of consecutive TLPs, carries out compression processing on each header of the TLPs as shown in FIGS. 9A and 9B, and adds, to the first header that includes all elements, information indicating that the headers have been compressed, in step S7.

After the step S5 or step S7, the CPU 23 supplies the TLP to the DataLink Layer 26b in step S8 and terminates the processing (step S9).

Additionally, when it is determined in step 4 that the amount of data (size) of the data payload has not been reduced after the compression processing (NO), or in step S6, a description of read request is not given in any of the headers of the plurality of consecutive TLPs (NO), the CPU 23 supplies the TLP to the DataLink Layer 26b in step S8, and terminates the processing (step S9).

FIG. 11 is a flowchart showing an operation sequence of decompressing the compressed data payload or header of the TLP in the device 26 described above. As a matter of course, the decompression processing in the device 24 also can be carried out in substantially the same manner as in the device 26.

That is, upon the start of processing (step S10), the CPU 23 determines in step S11 whether or not a compressed data payload is added to a TLP output from the DataLink Layer 26b. This determination can be made by detecting whether or not information indicating that the data payload has been compressed is added to a header of the TLP.

When it is determined that a compressed data payload is added to the TLP (YES), the CPU 23 supplies the TLP to the decompression circuit 42 and causes the decompression circuit 42 to decompress the data payload in step S12.

On the other hand, when it is determined in step S11 that no compressed data payload is added to a TLP output from the DataLink Layer 26b (NO), the CPU 23 determines in step S13 whether or not a header output from the DataLink Layer 26b has been compressed. This determination can be made by detecting whether or not information indicating that the header has been compressed is added to the header of the TLP.

After that, when it is determined that the header has been compressed (YES), the CPU 23 supplies the header to the decompression circuit 42, where the header is decompressed, in step S14. Subsequently to the step S12 or step S14, the CPU 23 supplies the TLP to the Transaction Layer 26c in step S15 and terminates the processing (step S16).

On the other hand, when it is determined in step S13 that the header has not been compressed (NO), the CPU 23 supplies the TLP to the Transaction Layer 26c in step S15 and terminates the processing (step S16).

According to the embodiment described above, a data payload or header of a TLP output from the Transaction Layer 24c of one device, i.e., the device 24 is compressed by the compression circuit 36, and goes through the DataLink Layer 24b, Physical Layer 24a, PCI Express link 34, and then through the Physical Layer 26a and DataLink Layer 26b of the other device, i.e., the device 26. Thereafter, the compressed data payload or header of the TLP is decompressed by the decompression circuit 42 and consequently supplied to the Transaction Layer 26c. As a result, the data transmission rate on the transmission path from the DataLink Layer 24b to the DataLink Layer 26b is lowered, and therefore the amount of data of the TLP transmitted and received between the devices 24 and 26 can effectively be reduced, which results in an improvement in transmission efficiency.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus incorporating a first device and a second device that are connected by a serial bus interface with each other and performs transmission of packets between transaction layers of the devices via data link layers, comprising:
a compression control unit which, when a data payload is added to a packet output from the transaction layer of the first device, performs compression processing on the data payload and supplies the compressed data payload to a data link layer of the first device; and
a decompression control unit which, when a compressed data payload is added to a packet received by a data link layer of the second device, performs decompression processing on the compressed data payload and supplies the decompressed data payload to a transaction layer of the second device.

2. The information processing apparatus according to claim 1, wherein
when the amount of data of the compressed data payload is smaller than the amount of data of the data payload before being compressed, the compressed data payload is supplied to the data link layer of the first device.

3. The information processing apparatus according to claim 1, wherein
when the compressed data payload is supplied to the data link layer of the first device, the compression control unit adds information indicating that the data payload has been compressed, to the header of a packet to which the compressed data payload is added.

4. The information processing apparatus according to claim 1, wherein
when no data payload is added to a packet output from the transaction layer of the first device and if the headers of a plurality of packets output consecutively from the transaction layer of the first device is compressible, the compression control unit performs compression processing on the headers and supplies the thus compressed headers to the data link layer of the first device.

5. The information processing apparatus according to claim 4, wherein
the compression control unit determines that each of the headers of the plurality of packets output consecutively from the transaction layer of the first device is compressible, when the most of a plurality of elements constituting the each header are identical to one another.

6. The information processing apparatus according to claim 5, wherein
the compression control unit performs compression processing on the plurality of headers by generating one single header that contains all elements and information in which elements of the headers other than the one single header which are nonidentical with one another are arrayed.

7. The information processing apparatus according to claim 4, wherein
the compression control unit adds, to the one single header containing all elements, information indicating that headers have been compressed, when the compressed headers are supplied to the data link layer of the first device.

8. The information processing apparatus according to claim 4, wherein
when a compressed data payload is not added to a packet received by the data link layer of the second device, the decompression control unit determines whether or not the header has been compressed, and when the header is determined to have been compressed, performs decompression processing on the header.

9. The information processing apparatus according to claim 1, wherein
the first device has a route that allows a packet output from the transaction layer to be directly supplied to the data link layer of the first device without causing the compression control unit to perform compression processing on the packet, and
the second device has a route that allows a packet received by the data link layer to be directly supplied to the transaction layer of the second device without causing the decompression control unit to perform decompression processing on the packet.

10. The information processing apparatus according to claim 1, wherein
the serial bus interface corresponds to PCI Express.

11. A method of controlling an information processing apparatus that incorporates first and second devices which are connected by a serial bus interface with each other and performs transmission of packets between transaction layers of the devices via data link layers, comprising:
when a data payload is added to a packet output from a transaction layer of the first device, executing compression processing on the data payload and supplying the compressed data payload to a data link layer of the first device; and
when a compressed data payload is added to a packet received by a data link layer of the second device, executing decompression processing on the compressed data payload and supplying the decompressed data payload to a transaction layer of the second device.

12. The method of controlling an information processing apparatus according to claim 11, wherein
the process of compressing a data payload and supplying the compressed data payload to the data link layer of the first device is performed by supplying the compressed data payload to the data link layer of the first device, when the amount of data of the compressed data payload is smaller than the amount of data of the data payload before being compressed.

13. The method of controlling an information processing apparatus according to claim 11, wherein
the process of compressing a data payload and supplying the compressed data payload to the data link layer of the first device is performed by compressing headers of a plurality of packets output consecutively from the transaction layer of the first device and supplying the thus compressed headers to the data link layer of the first device, when no data payload is added to a packet output from the transaction layer of the first device and if the headers of the plurality of packets are compressible.

14. The method of controlling an information processing apparatus according to claim 13, wherein
the process of decompressing a compressed data payload and supplying the decompressed data payload to the transaction layer of the second device is performed by, when no compressed data payload is added to a packet received by the data link layer of the second device, determining whether or not a header has been compressed, and when the header is determined to have been compressed, decompressing the header.
